(19) United States
(12) Patent Application Publication
(10) Pub. No.: US 2011/0019178 A1
(43) Pub. Date: Jan. 27, 2011

(54) Method for post processing fiber optic strain measurement data

(76) Inventor: Christos Vlatas, Houston, TX (US)

Correspondence Address: Christos Vlatas, 1014 Fleetwood Pl. Dr., Houston, TX, 77079, US

(21) Appl. No.: 12/460,593

(22) Filed: Jul. 22, 2009

(51) Int. Cl. G01B 11/16; G01N 21/00

(52) U.S. Cl. 356/32; 356/73.1

(57) ABSTRACT

Distributed Strain Sensing (DSS) systems are used to measure strain using optical fibers functioning as linear sensors. Strain is measured along the fiber optic cable over large distances using a BOTDR (Brillouin Optical Time Domain Reflectometer) which is a Fiber Optic Strain Analyzer based on Brillouin technology. This measurement is popular in the Geotechnical field to monitor structural integrity of bridges, tunnels, mines etc. It is also popular in many industries including the Oil and Gas industry. The procedure involves recording strain data traces periodically to compare structural changes that may have developed over time. However, it is difficult to observe small changes from the raw data traces. This is due to the large number of data points and strain irregularities inherited in the fiber cable. This invention provides a simple and economical way to observe clearly very small strain changes acting on a structure. This is done by post processing the data traces with a low pass filter. The data traces are smoothed out and small strain differences can be easily observed and analyzed.

### BACKGROUND OF THE INVENTION

Distributed Strain System applications using fiber optic technology has provided an economical and accurate means of measuring strain on structures over long distances usually in kilometers. The strain data is normally obtained using BOTDR instrumentation with spatial resolution of less than a meter. Apart from having a large number of data points, the data appears noisy due to the strain irregularities inherited in the fiber. The noisy appearance is also contributed due to the strain distribution caused by the method used in mounting the fiber optic cable on a structure. The data is recorded periodically and compared to identify changes that may have occurred on a structure over time.

The method described in this invention provides a very effective, practical and economical method to filter strain data obtained from a BOTDR instrument and clearly identify very small changes that have occurred on a structure. The detection of structural changes at an early stage is detrimental in geotechnical applications.

### SUMMARY

The present invention is to provide an easy, reliable and inexpensive method to filter a strain data record and clearly identify very small changes in fiber optic strain measurements.

The BOTDR strain measurement is affected by temperature. The temperature profile along the path of the optical fiber is obtained using different techniques and the correction is applied to the strain measurement

A strain data record contains measured value of strain vs. distance. Each record is read by a software application. The application plots each record to be compared with previous records to identify strain changes. The raw data records, however, closely overlap one another and have fluctuations that make it difficult to observe small changes.

A digital low pass digital filter is implemented in the software application to process the raw data. The filtered data clearly show small changes that indicate early detection of structural deformity.

The method in this invention shows how to apply the settings on a digital low pass filter, to obtain a clear indication of structural changes from the raw data.

The method is illustrated with actual data obtained from a monitor well to observe terrain subsidence in the vicinity of a mine.

### BRIEF DESCRIPTION OF DRAWINGS

FIG. 1 is diagram illustrating an embodiment of hardware setup.

FIG. 2 is diagram illustrating an embodiment of geotechnical observation well hardware setup.

FIG. 3 is diagram illustrating an embodiment of geotechnical observation well temperature profile.

FIG. 4 is diagram illustrating an embodiment of BOTDR raw data.

FIG. 5 is a diagram illustrating an embodiment of BOTDR filtered data with sampling frequency 0.5 Hz, cutoff frequency 0.005 Hz and filter order 5.

FIG. 6 is a diagram illustrating an embodiment of BOTDR filtered data with sampling frequency 0.5 Hz, cutoff frequency 0.0025 Hz and filter order 5.

FIG. 7 is a diagram illustrating an embodiment of BOTDR filtered data with sampling frequency 100 Hz, cutoff frequency 1.0 Hz and filter order 5.

FIG. 8 is a diagram illustrating an embodiment of BOTDR filtered data with sampling frequency 100 Hz, cutoff frequency 0.5 Hz and filter order 5.

FIG. 9 is a diagram illustrating an embodiment of BOTDR filtered data with sampling frequency 100 Hz, cutoff frequency 0.5 Hz and filter order 1.

### DETAILED DESCRIPTION OF THE PREFERRED EMBODIMENT

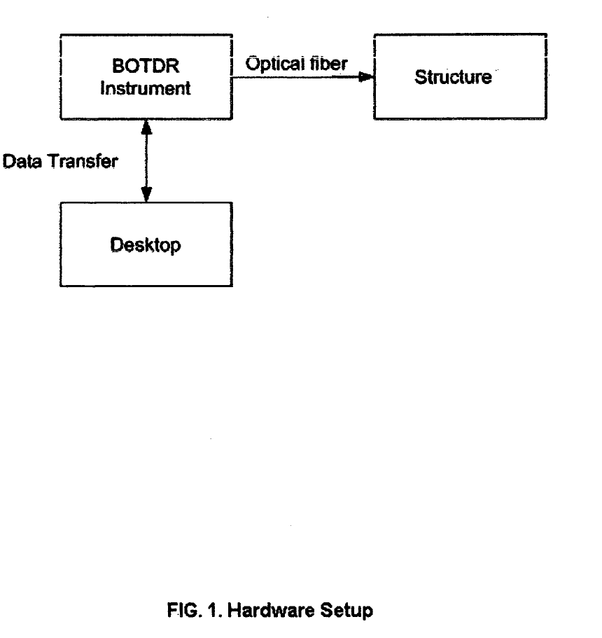

A BOTDR provides raw data of strain vs. distance. FIG. 1 shows the hardware setup where the data is acquired by the BOTDR and is transferred to the Desktop. The data is read by an application to post process the data with a software digital low pass filter. The application can be written in any software language.

The strain data is acquired a BOTDR instrument. The strain measurement is affected by temperature and the temperature contribution is corrected by acquiring the temperature profile of the optical fiber and calculating the strain contribution due to temperature. The temperature profile can be measured using different techniques. It suffices to mention that the method in this invention applies to raw strain data or temperature corrected data.

A low pass filter is used to filter the raw data. There are three filter parameter settings that need to be populated to give good results. These include the sample rate, the cutoff frequency and the filter order.

The sample frequency can be chosen arbitrarily. The cutoff frequency can be any fraction of the sampling frequency. The sampling frequency has to be at least twice the cutoff frequency to abide by Nyquist law. The filter order can be any number greater than 1 bearing in mind that high numbers affect the phase significantly. Keeping the ratio between the sampling frequency and the cutoff frequency constant the filtering effect on the data remains the same.

The sample frequency can be modeled from the distance interval of the acquired data. This can be every 0.5 meters or any multiple depending on the spatial resolution of the acquired strain data. This means that a strain reading is taken every 0.5 meters. In this scenario, the sample frequency can be chosen as 0.5 Hz.

The cutoff frequency can be any fraction of the sampling frequency. It can be 1/50^{th} or 1/100^{th} of the sampling frequency. In this example it can be 0.5/100=0.005 Hz. The data can be smoothed out further by reducing the cutoff frequency by ½ say 0.005/2=0.0025 Hz and so on. The cutoff frequency can then be fine tuned by 0.001 Hz up or down to obtain the preferred response. These are details that are dependent on the preference of the user and the quality of the data. The filter order can be changed from 1 to 5 without affecting the phase significantly.

As mentioned above, the selection of the sampling frequency can be chosen arbitrarily; however, the difference of the cutoff frequency to the sampling frequency determines the filtering effect. In the example above the sampling frequency is chosen 0.5 Hz and the cutoff frequency is 0.0025 Hz. The ratio is 0.5/0.0025=200. On the same token, a sampling frequency of 100 Hz and a cutoff frequency of 100/200=0.5 Hz give the same filtering results.

The same filter settings are applied to all the BOTDR traces. When the traces are plotted on the same graph, very small strain changes can be easily observed and measured.

### Example

Data obtained from a Geotechnical observation well is submitted as an example to illustrate and not limit the invention. The data from this well is ideal to show small changes of strain induced by temperature.

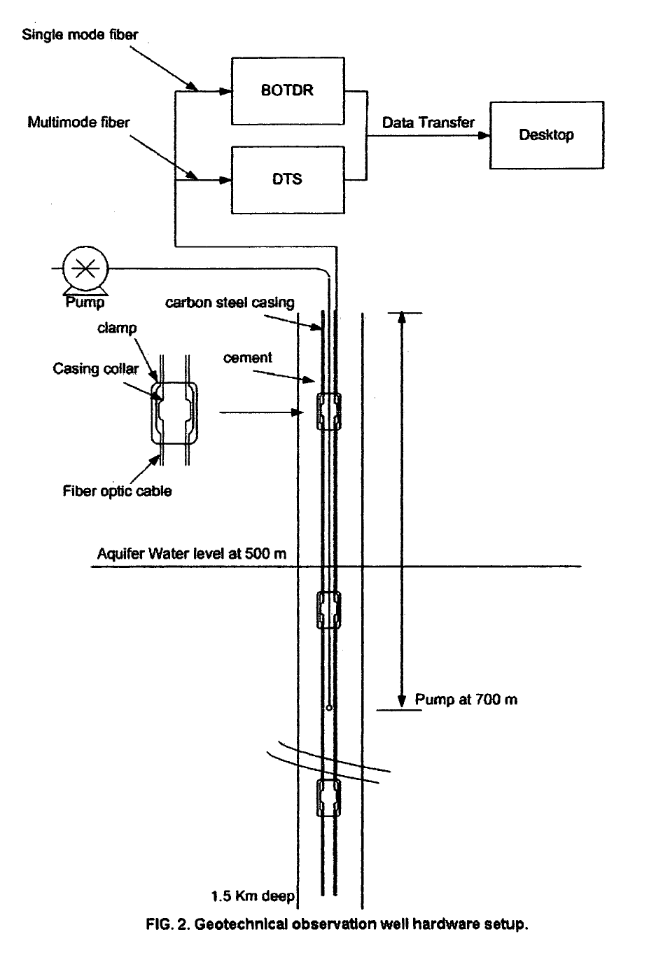

The hardware setup is shown in FIG. 2. A Geotechnical observation well is drilled 1.5 Km deep in the vicinity of a mine to monitor land subsidence. A carbon steel casing normally used in the Oil and Gas industry is installed in the well. Fiber optic cables are attached at the outer wall of the casing as it is being lowered in the well. A clamp secures and protects the cable at each casing collar as shown in FIG. 2. The well is cemented and the fiber is routed to the instrumentation to measure strain and temperature

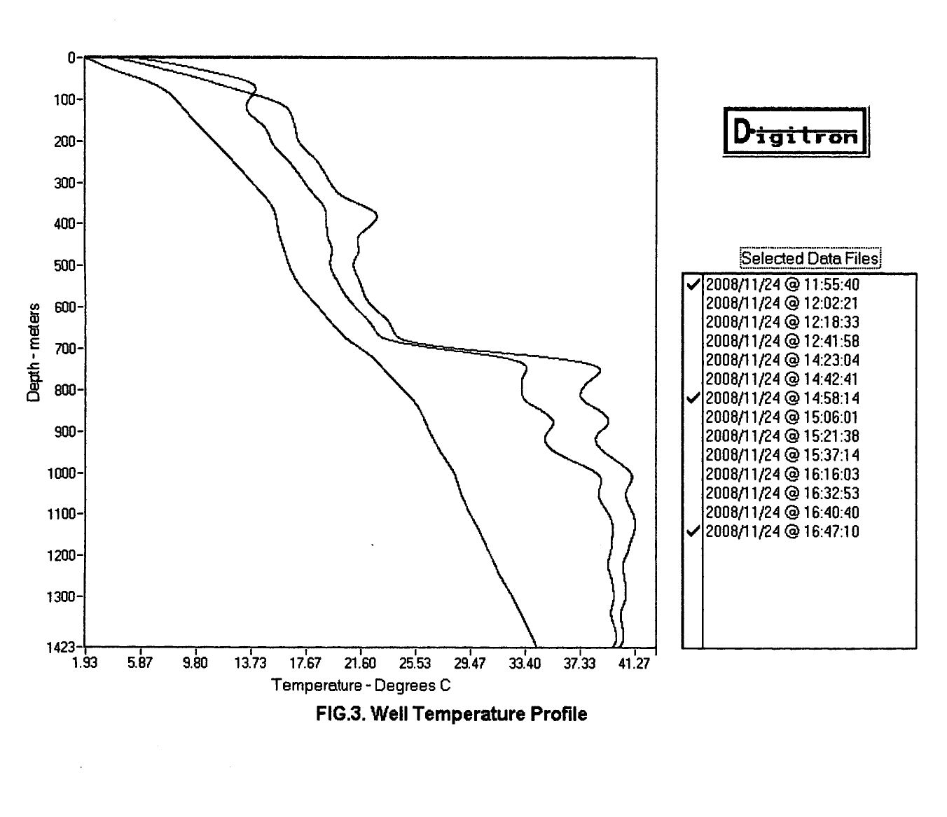

The well contains water from aquifers at depths below 500 meters. The water is at 40 C starting at 500 meters and it gets hotter with depth. Water is pumped out from about 600 meters as shown in FIG. 2. The well temperature profile is shown in FIG. 3. The Y-axis is depth and the X-axis is strain. The peaks in the plot are due to strain applied on the fiber by the clamps during installation. The temperature increases due to the hotter water from the deeper region reaching the cooler upper region during pumping.

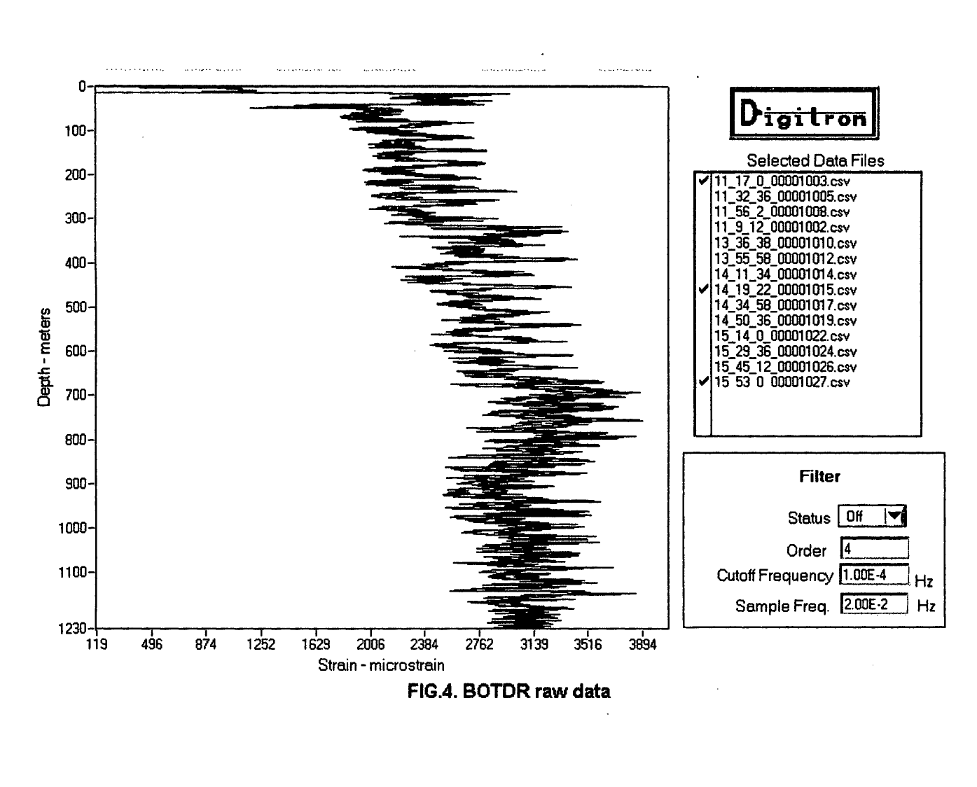

The increase in temperature caused structural changes to take place. This example serves the purpose to illustrate small structural changes caused by the gradual increase of temperature caused by the hotter water coming from lower depths. The raw data obtained from the BOTDR is shown in FIG. 4. It is difficult to observe changes on the graph in FIG. 4. However, there are changes in the strain response of the fiber. These changes are partially due to the temperature increase and partially due to the structural deformation of the casing.

The temperature profile shown in FIG. 3 is acquired by a DTS 5100 Fiber Optic Distributed Temperature Sensing (DTS) instrument by Sensortran. The strain raw data is acquired by an AQ8603 BOTDR by Yokogawa. The data is processed with a software application written in C using LabWindows from National Instruments. The application implements a software digital low pass filter. The sample rate, cutoff frequency and filter order settings were chosen using the method in this invention.

The function call used in this example is:

Bw_{—}LPF(x[ ],n,sf,cf,order,y[ ]);

Where:
x[ ]=input array (double).
n=number of elements (integer),
sf=sampling frequency (double),
cf=cutoff frequency (double),
or=order (integer),
y[ ]=output array (double).

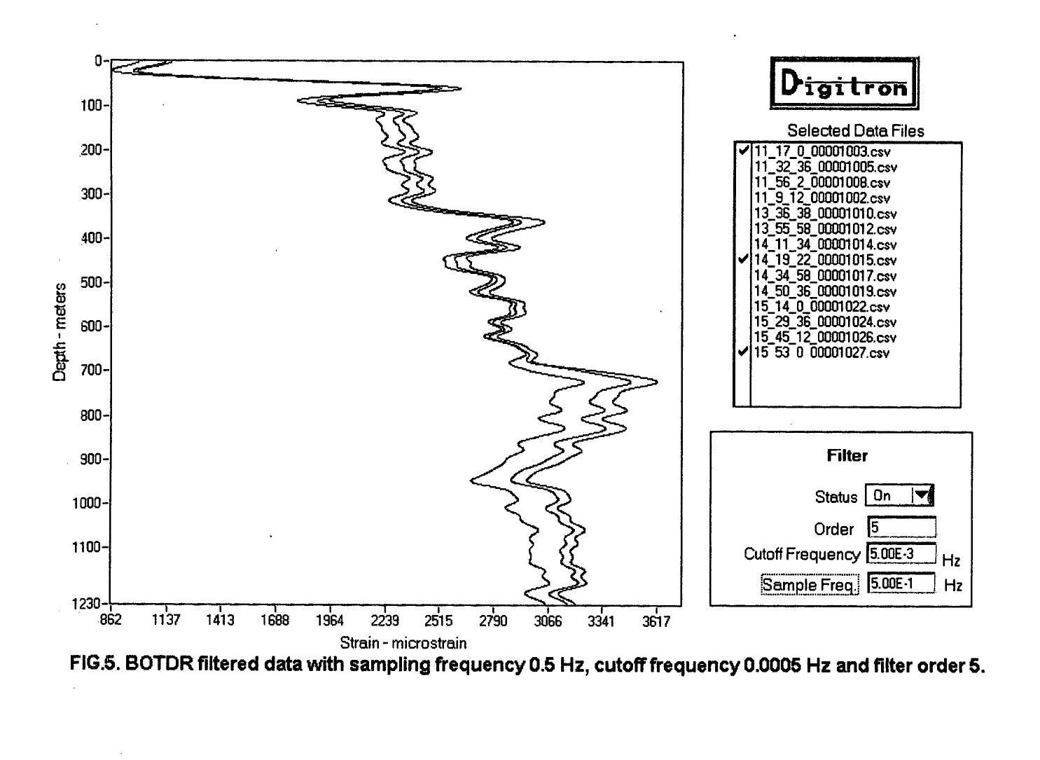

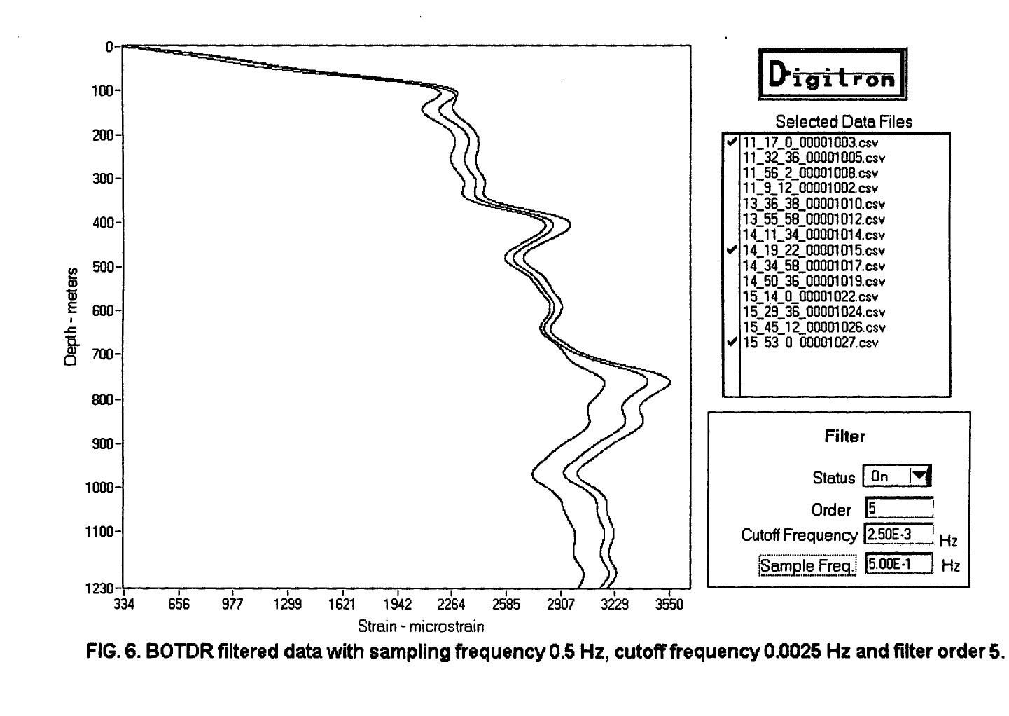

The graph in FIG. 5 shows processed data after applying a low pass filter. The change in strain due to temperature can be clearly seen in detail. The spatial resolution on the data is every 0.5 meters. The low pass filter sampling frequency in this illustration is assumed to be 0.5 Hz. A good choice for the cutoff frequency can be 100 times lower than the sampling frequency. In this case 0.005 Hz. The filter order is 5. The graph in FIG. 5 shows the response at these settings. If a smoother response is desired then the cutoff frequency can be lowered by a factor of 2. In this case 0.0025 Hz. The response is shown in FIG. 6.

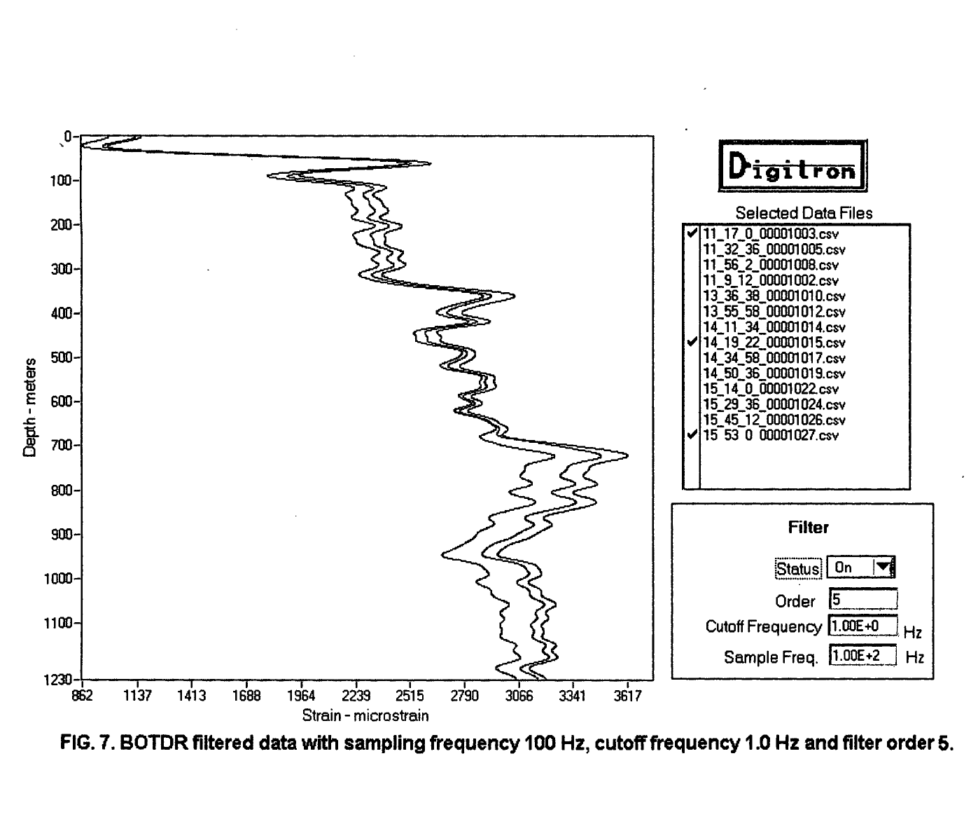

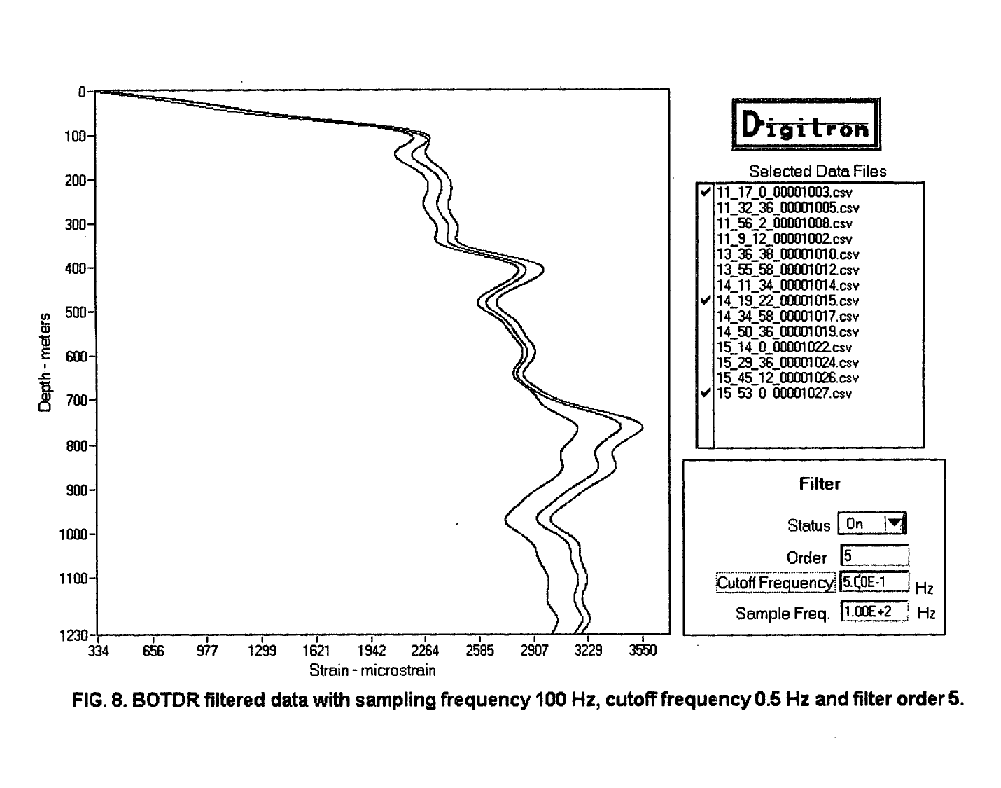

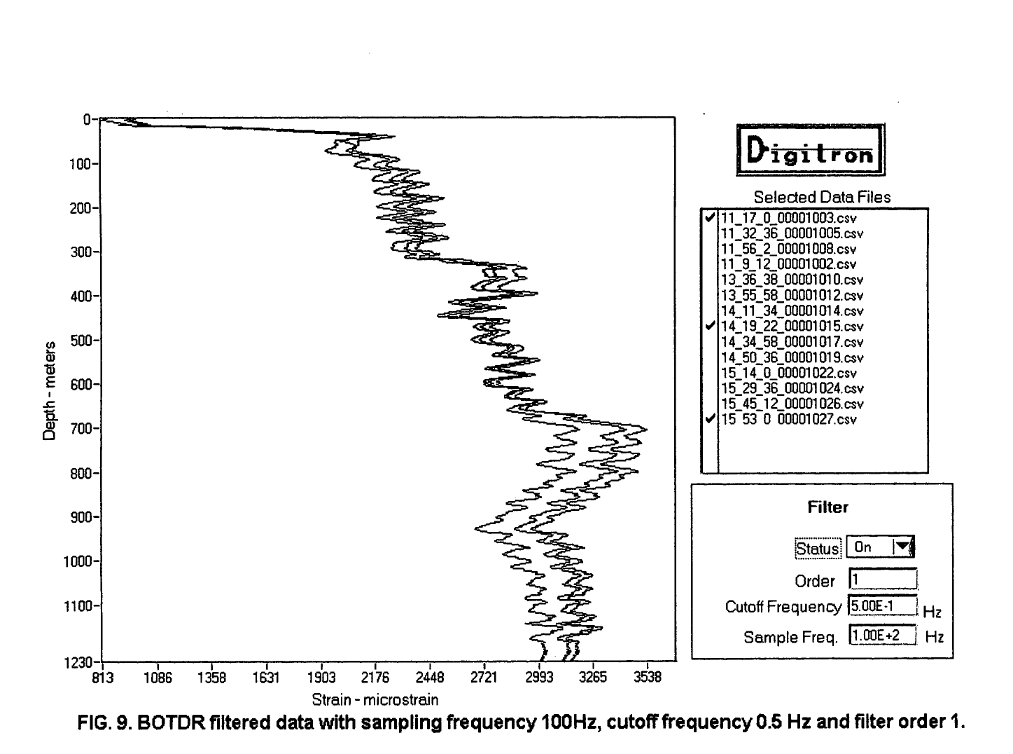

The choice of the sampling frequency is arbitrary in similar applications. However, the cutoff frequency is dependent on the sampling frequency and the Nyquist principle has to be observed. This is illustrated by setting the sample frequency to: 100 Hz. The cutoff frequency (100/100=1) is set to 1.0 Hz. The filter order is kept at 5. The response is shown in FIG. 7. Again for a smoother response, the cutoff frequency can be 0.5 Hz shown in FIG. 8. The filter order can be in the range between 1 and 5. FIG. 9 shows the response at sample frequency 100 Hz, cutoff frequency 0.5 Hz and filter order 1. The only parameter changed between FIG. 8 and FIG. 9 is the filter order which was changed from 5 to 1. At higher filter orders the phase change is significant.

1. A method to post process fiber optic strain measurement data obtained from a fiber optic strain analyzer referred to as BOTDR (Brillouin Optical Time Domain Reflectometer).

2. A method to post process fiber optic strain data within the BOTDR instrumentation.

3. A method to post process fiber optic strain data after temperature correction.

4. A method to post process fiber optic strain data using Software Digital Filter applied to BOTDR measurements.

5. A method to post process fiber optic strain data using Software Digital Filter applied to BOTDR measurements after applying temperature correction.

6. The method further comprises a computer.

7. The method further comprises a software utility to perform digital filtering.

8. The method further comprises of data obtained from a BOTDR instrument using the spontaneous Brillouin method.

9. The method further comprises of data obtained from a BOTDR instrument using the stimulated Brillouin method.
